(19) United States
(12) Patent Application Publication
(10) Pub. No.: US 2012/0044448 A1
(43) Pub. Date: Feb. 23, 2012

(54) LIQUID CRYSTAL DISPLAY

(75) Inventors: Hyang-Yul KIM, Hwaseong-si (KR); Dong-Gyu KIM, Yongin-si (KR); Joo-Nyung JANG, Hwaseong-si (KR); Sung-Woon KIM, Suwon-si (KR); Hwa-Sung WOO, Asan-si (KR); Cheol SHIN, Hwaseong-si (KR); Dong-Chul SHIN, Seoul (KR)

(73) Assignee: SAMSUNG ELECTRONICS CO., LTD., Suwon-si (KR)

(21) Appl. No.: 13/107,567

(22) Filed: May 13, 2011

(30) Foreign Application Priority Data
Aug. 18, 2010 (KR) 10-2010-0079990

(51) Int. Cl. G02F 1/1343; H01J 9/00

(52) U.S. Cl. 349/141; 349/143; 445/46

(57) ABSTRACT

Exemplary embodiments of the present invention provide a liquid crystal display that includes a first substrate, a gate line positioned on the first substrate, a data line and a voltage line crossing the gate line, a first switching element connected to the gate line and the data line, a second switching element connected to the gate line and the voltage line, a first pixel electrode connected to the first switching element and including a plurality of branches inclined with respect to the gate line, and a second pixel electrode connected to the second switching element and including a plurality of branches parallel to the first branches, wherein the sum of the lengths of the first branches is 90% to 100% of the sum of the lengths of the second branches.

### CROSS-REFERENCE TO RELATED APPLICATION

This application claims priority to and the benefit of Korean Patent Application No. 10-2010-0079990 filed on Aug. 18, 2010, which is hereby incorporated herein by reference for all purposes as if fully set forth herein.

### BACKGROUND OF THE INVENTION

1. Field of the Invention

Exemplary embodiments of the present invention relates to a liquid crystal display.

2. Description of the Background

A liquid crystal display (LCD) has been adopted as one of the most widely used flat panel displays and an LCD typically includes two display panels where electric field generating electrodes such as a pixel electrode and a common electrode are formed and a liquid crystal layer interposed therebetween. The LCD generates an electric field in the liquid crystal layer by applying voltage to an electric field generating electrode, and the electric field that determines an orientation of liquid crystal molecules of the liquid crystal layer and controls polarization of incident light to display an image.

In general, the liquid crystal display receives an input image signal from an external graphic controller. The input image signal contains luminance information of each pixel. Each luminance has a predetermined number. Each pixel is applied with a data voltage corresponding to desired luminance information. The data voltage applied to the pixel is represented as a pixel voltage depending on a difference of a common voltage. Each pixel displays luminance indicated by the gray of the image signal depending on the pixel voltage.

However, the luminance of each pixel may vary according to variables, for example, a parasitic capacitance that may be formed between pixel electrodes, a process error, and various types of asymmetric pixel electrodes and common electrodes that may cause a flickering error.

Therefore, there is a need for an approach to solve flickering problem.

The above information disclosed in this Background section is only to set up Applicant's recognition of problems within existing art and merely for enhancement of understanding of the background of the invention based on the identified source of problems, and therefore the above information cannot be used as prior art in determining obviousness into the present invention.

### SUMMARY OF THE INVENTION

Exemplary embodiments of the present invention provide a liquid crystal display capable of preventing a flickering error.

Additional features of the exemplary embodiments will be set forth in the description which follows, and in part will be apparent from the description, or may be learned by practice of the invention.

Exemplary embodiments of the present invention disclose a liquid crystal display. The liquid crystal display includes a substrate comprising a gate line, a data line and a voltage line which crosses the gate line. The liquid crystal display also includes a first switching element which is connected to the gate line and the data line. The liquid crystal display includes a second switching element which is connected to the gate line and the voltage line. The liquid crystal display further includes a first pixel electrode which is connected to the first switching element, and the first pixel electrode includes a plurality of first branches inclined with respect to the gate line. The liquid crystal display includes a second pixel electrode which is connected to the second switching element, and the second electrode includes a plurality of second branches parallel to the first branches, wherein the sum of the lengths of the first branches is substantially similar to and not more than about 10% of the sum of the lengths of the second branches.

Exemplary embodiments of the present invention disclose a liquid crystal display which includes a first substrate including a first pixel electrode and a second pixel electrode forming a matrix, a second substrate facing the first substrate, and a liquid crystal layer interposed between the first substrate and the second substrate. The liquid crystal display also includes a gate line disposed on the first substrate. The liquid crystal display includes a data line and a voltage line crossing the gate line. The liquid crystal display includes a first switching element which is connected to the gate line and the data line. The liquid crystal display includes a second switching element connected to the gate line and the data line. The first pixel electrode includes a plurality of first branches inclined with respect to the gate line, the second pixel electrode includes a plurality of second branches inclined with respect to the gate line, and a sum of lengths of the first branches is about 90% to 100% of a sum of lengths of the second branches, and wherein the first pixel electrode positioned on a first row of a matrix is alternately connected to the first switching element and the second switching element corresponding to changing of the column of the matrix, and the second pixel electrode positioned on a first row of the matrix is alternately connected to the second switching element and the first switching element inverse to the first pixel electrode corresponding to changing of the column of the matrix.

Exemplary embodiments of the present invention disclose a method. The method includes disposing a pixel electrode including a first electrode and a second electrode and the pixel electrode including a vertical stem, a horizontal stem including an upper stem, a central stem and a lower stem and a plurality of branches, wherein the respective branches corresponding to each of the first electrode and the second electrode is alternatively arranged at an interval with an oblique orientation approximately 45 degree with respect to the vertical stem or the horizontal stem.

It is to be understood that both the foregoing general description and the following detailed description are exemplary and explanatory and are intended to provide further explanation of the invention as claimed.

### BRIEF DESCRIPTION OF THE DRAWINGS

FIG. 1 is a circuit diagram showing a pixel in a structure of a liquid crystal display according to exemplary embodiments of the present invention.

FIG. 2 is a schematic cross-sectional view of a liquid crystal display according to exemplary embodiments of the present invention.

FIG. 3 is a diagram showing a pixel electrode of a liquid crystal display according to exemplary embodiments of the present invention.

FIG. 4 and FIG. 5 are layout diagrams showing a connection relationship between a pixel electrode and a signal line of a liquid crystal display according to exemplary embodiments of the present invention.

FIG. 6 and FIG. 7 are diagrams showing charged voltages of liquid crystal capacitors of eight adjacent pixels and data voltages applied to data lines that are displayed in two successive frames using a minimum voltage and a maximum voltage which are 0V and 15V, respectively, according to exemplary embodiments of the present invention.

FIG. 8 is a flowchart of a process for making a pixel electrode capable of preventing a flickering error caused by a luminance difference according to exemplary embodiments of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity Like reference numerals in the drawings denote like elements.

It is understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It is understood that although numerical terms such as a first, a second, and a third may be used herein to describe various elements, components, regions, layers and/or sections, these elements, components, regions, layers and/or sections should not be limited by these numerical terms. These terms may only be used to distinguish one element, component, region, layer or section from another region, layer or section. Thus, an element, a component, a region, a layer or a section designated as “first” discussed below may be construed an element, a component, a region, a layer or a section designated as “second” without departing from the teachings of the present invention.

It is understood that terms related to spatially relative terms such as “beneath,” “below,” “lower,” “above,” “upper” may be used herein for easy understanding of illustration of one element or feature's relationship to another element(s) or feature(s) as illustrated in the figures. It is understood that the spatially relative terms may be intended to encompass different orientations of the device in use or operation in addition to the orientation depicted in the figures. For example, if the device in the figures is turned over, elements described as “below” or “beneath” other elements or features may be oriented “above” the other elements or features. Thus, the exemplary term “below” may encompass both an orientation of above and below. According to an exemplary configuration, a device may be otherwise oriented to a direction (e.g., rotated 90 degrees or at other orientations) and the spatially relative terms used herein associated with other elements and/or features may be interpreted accordingly.

The terminology used herein is for the purpose of describing exemplary embodiments only and may not be intended to be limiting of the present invention. As used herein, the singular forms “a,” “an” and “the” are intended to include the plural forms as well, unless the context clearly indicates otherwise. It is further understood that the terms “comprises” and/or “comprising,” when used in this specification, specify the presence of stated features, integers, steps, operations, elements, and/or components, but these terms do not preclude the presence or addition of one or more other features, integers, steps, operations, elements, components, and/or groups thereof.

Exemplary embodiments of the invention are described herein with reference to cross-sectional illustrations that are schematic illustrations of idealized exemplary embodiments (and intermediate structures) of the present invention. As such, various exemplary embodiments are illustrated by way of examples, and not by way of limitation, for example, variations due to manufacturing techniques and/or tolerances may be expected. Thus, illustrated exemplary embodiments of the present invention should not be construed as limited to the particular shapes of regions illustrated herein but may be construed to include deviations in shapes that may be resulted from manufacturing configurations. For example, an implanted region illustrated as a rectangular shape may, typically, have rounded or curved features and/or a gradient of implant concentration at its edges rather than a binary change from implanted to non-implanted region. Thus, the regions illustrated in the figures are illustrative in nature and their shapes are not intended to restrict the actual shape of a region of a device and are not intended to limit the scope of the present invention.

Unless otherwise defined, all terms (including technical and scientific terms) used herein have the similar meanings as commonly understood by one of ordinary skill in the art to which this invention belongs. It is further understood that terms, such as those defined in commonly used dictionaries, should be interpreted as having a meaning that is consistent with their meaning in the context of the relevant art and will not be interpreted in an idealized or overly formal sense unless expressly so defined herein.

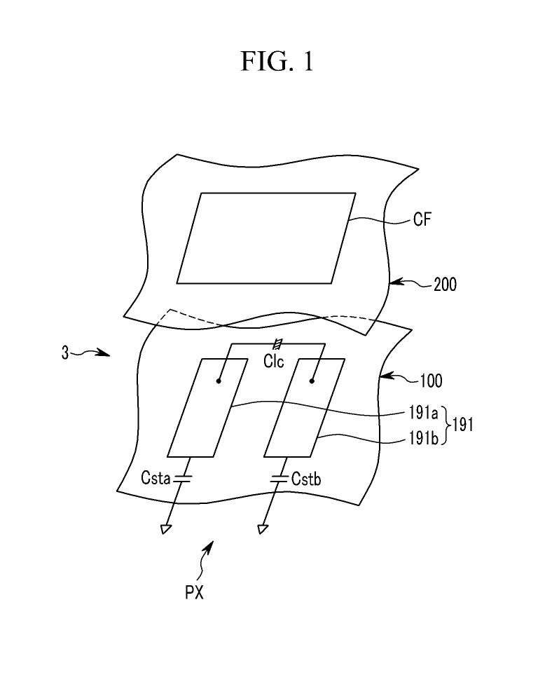

FIG. 1 is a circuit diagram showing a pixel in a structure of a liquid crystal display according to exemplary embodiments of the present invention.

Referring to FIG. 1, the liquid crystal display includes lower display panel 100 and a upper display panel 200 facing each other and a liquid crystal layer 3 interposed therebetween.

A liquid crystal capacitor Clc includes a first pixel electrode 191a and a second pixel electrode 191b of the lower display panel 100 as two terminals. The liquid crystal layer 3 interposed between the first pixel electrode 191a and the second pixel electrode 191b serves as a dielectric. The first pixel electrode 191a is connected to a first switching element (not shown) and the second pixel electrode 191b is connected to a second switching element (not shown). The first switching element and the second switching element are connected to a gate line (not shown) and a data line (not shown) corresponding thereto, respectively.

The liquid crystal layer 3 has dielectric anisotropy and liquid crystal molecules that may be aligned to have long axes vertical with respect to the surfaces of two display panels without an electric field.

In some examples, the first pixel electrode 191a and the second pixel electrode 191b may be formed on different layers or on the same layer. A first storage capacitor (not shown) and a second storage capacitor (not shown) that perform an auxiliary role of the liquid crystal display may be formed by overlapping an additional electrode (not shown) provided on the lower display panel 100 with the first pixel electrode 191a and the second pixel electrode 191b, respectively, with an insulator interposed therebetween.

To display an image, for example, each pixel PX may uniquely display one of primary colors (spatial division) or each pixel PX may alternately display the primary colors depending on the time (temporal division) to allow a desired color to be recognized through the spatial and temporal sums of the primary colors in order to implement color display.

Examples of the primary colors may include three primary colors including red, green, and blue. FIG. 1 shows each pixel PX that includes a color filter CF representing one of the primary colors in a region of the upper display panel 200 corresponding to the first pixel electrode 191a and the second pixel electrode 191b as an example of the spatial division. Alternatively, the color filter CF may be disposed above or below the first pixel electrode 191a and the second pixel electrode 191b of the lower display panel 100.

At least one polarizer (not shown) may be provided on the outer surface of each of the upper display panel 200 and the lower display panel 100.

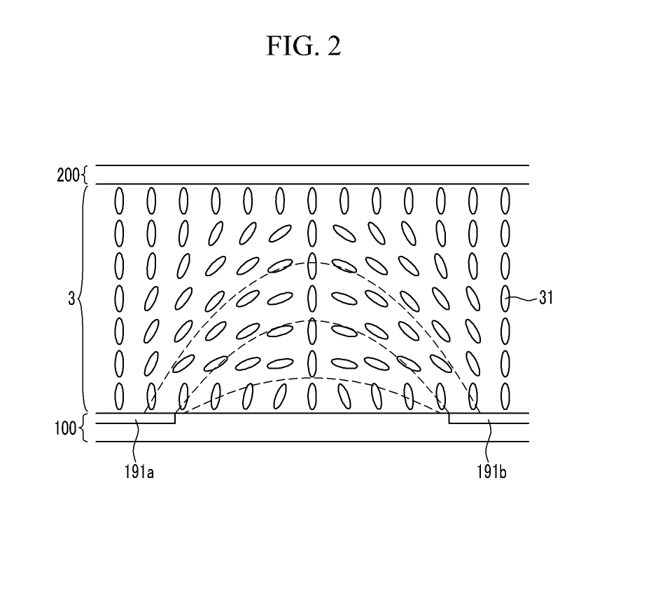

According to exemplary embodiments, a driving method of a liquid crystal display is described in detail with respect to FIG. 2 and FIG. 1.

FIG. 2 is a schematic cross-sectional view of a liquid crystal display according to exemplary embodiments of the present invention.

Referring to FIG. 1 and FIG. 2, when the switching element is turned on by a gate-on signal transferred through a gate line, a data voltage applied to the data line is applied to the corresponding pixel PX through the switching element which is turned on. In this example, the data voltage is applied to one of the first pixel electrode 191a and the second pixel electrode 191b and a predetermined voltage or two swing voltages may be alternately applied to the other one. In this example, the applied data voltage corresponds to luminance to be displayed by the pixel PX. The predetermined voltage or two swing voltages may have polarities opposite to each other with respect to a reference voltage Vref.

A difference between the two voltages applied to the first pixel electrode 191a and the second pixel electrode 191b is represented as the charge voltage of the liquid crystal capacitor Clc, that is, a pixel voltage. When a potential difference is generated on both terminals of the liquid crystal capacitor Clc, an electric field which is parallel to the surfaces of the display panels 100 and 200 is generated on the liquid crystal layer 3 interposed between the first pixel electrode 191a and the second pixel electrode 191b as shown in FIG. 2.

If the liquid crystal molecules 31 have positive dielectric anisotropy, the liquid crystal molecules 31 are inclined to have long axes parallel to the direction of the electric field and the inclination degree depends on the magnitude of the pixel voltage. The liquid crystal layer 3 is referred to as an electrically-induced optical compensation (EOC) mode. The polarization variation degree of light that penetrates the liquid crystal layer 3 varies depending on the inclination degree of the liquid crystal molecules 31. The polarization variation is represented as the variation of transmittance of light by a polarizer and as a result, the pixel PX displays predetermined desired luminance.

By applying two voltages having different polarities with respect to the reference voltage Vref to one pixel PX, a high driving voltage difference can be acquired, the response speed of the liquid crystal molecule can be increased, and the transmittance of the liquid crystal display can be improved.

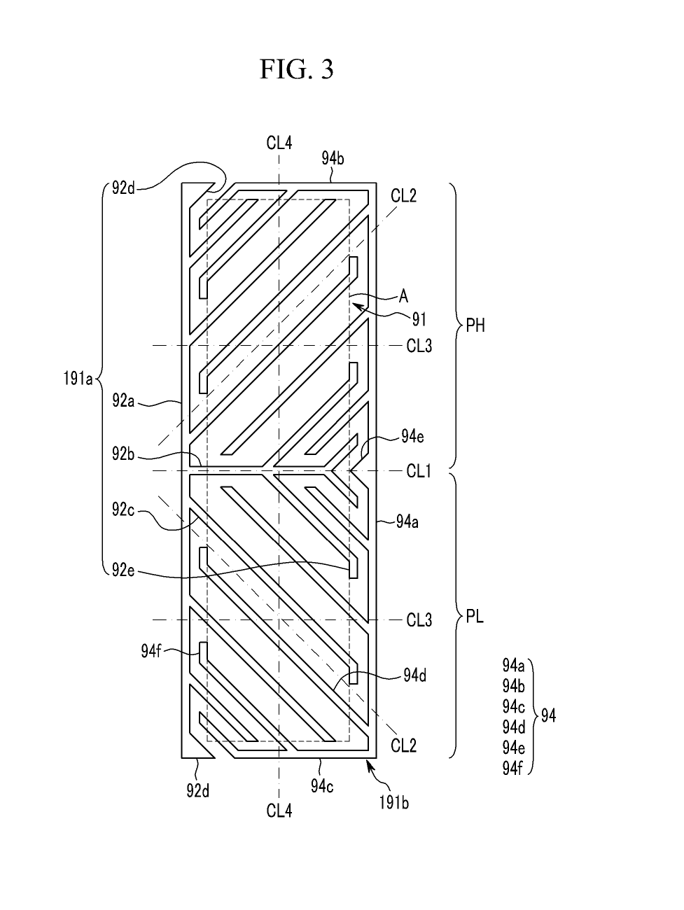

A type of the pixel electrode included in a pixel of the liquid crystal display is described in more detail with reference to the FIG. 3.

FIG. 3 is a diagram showing a pixel electrode of a liquid crystal display according to exemplary embodiments of the present invention.

As shown in FIG. 3, in the liquid crystal display according to exemplary embodiments of the present invention, the overall outer shape of the pixel electrode is quadrangular and a branch 92c of the first pixel electrode 191a and a branch 94d of the second pixel electrode 191b are alternately disposed at a predetermined interval.

The first pixel electrode 191a includes a first vertical stem 92a positioned at the left side of the pixel, a horizontal stem 92b that extends to the right side from the center of the first vertical stem 92a, and a plurality of branches 92c. Both ends of the first vertical stem 92a are connected to a triangular protrusion 92d and the end of a part of the branch 92c is connected to an extension 92e parallel to the first vertical stem 92a.

The branch 92c extends obliquely in right upper and lower directions from the first vertical stem 92a, and the branch 92c is inclined at approximately 45° with respect to the first vertical stem 92a and the horizontal stem 92b. A side of the protrusion 92d facing the branch 92c is parallel to the branch 92c.

The protrusion 92d and the extension 92e prevent texture or light leakage which is generated at the corner of the pixel or the edge of a domain.

The extension 92e of the first pixel electrode 191a is formed to a portion of the branch 92c that is adjacent to the second vertical stem 94a if the branch 92c extends.

The second pixel electrode 191b includes a second vertical stem 94a positioned at the right side of the pixel, and an upper horizontal stem 94b and a lower horizontal stem 94c that are connected to both ends of the second vertical stem 94a and extend toward the protrusion 92d of the first vertical stem 92a. In addition, the second pixel electrode 191b includes a plurality of branches 94d.

The second vertical stem 94a includes an isosceles triangular protrusion 94e that protrudes toward the central horizontal stem 92b. An oblique side of the protrusion 94e is parallel to the branch 92c and the protrusion 94e protrudes towards in a concave portion formed by the branch 92c that extends vertically from the end of the central horizontal stem 92b.

The branch 94d extends obliquely in a lower left direction or in an upper left direction from the second vertical stem 94a, the upper horizontal stem 94b, and the lower horizontal stem 94c and is inclined at approximately 45° with respect to the second vertical stem 94a or the upper horizontal stem 94b and the lower horizontal stem 94c.

The end of a part of the branch 94d is connected to an extension 94f which is parallel to the second vertical stem 94a. The extension 94f of the second pixel electrode 191b is formed to a portion of the branch 94d that is adjacent to the first vertical stem 92a if the branch 94d extends.

The extension 92e of the first pixel electrode 191a is positioned adjacent to the second vertical stem 94a and the extension 94f of the second pixel electrode 191b is positioned adjacent to the first vertical stem 92a to prevent light leakage due to the texture in those parts.

Boundaries of the branch 92c of the first pixel electrode 191a and the branch 94d of the second pixel electrode 191b that face each other are parallel to each other. Two branches 92c and 94d are alternately disposed to form a cross hatch pattern while engaging in each other. Two branches 92c and 94d may be disposed at regular intervals. Since the intensity of an electric field due to the branches 92c and 94d may be increased by narrowing the interval at a portion where the texture is easily generated, such as the corner of the pixel, the interval between two branches 92c and 94d is adjusted by way of configurations.

The pixel electrode 191 including the first pixel electrode 191a and the second pixel electrode 191b is symmetric on the basis of a virtual horizontal center line CL1. Hereinafter, for better understanding of description, an upper region of the virtual horizontal center line of the pixel electrode 191 is referred to as an upper pixel electrode PH and a lower region of the virtual horizontal center line of the pixel electrode 191 is referred to as a lower pixel electrode PL.

For example, a pixel electrode positioned at the upper pixel electrode PH is divided by a virtual diagonal line CL2 that extends toward the branches 92c and 94d and the pixel electrode positioned at the upper pixel electrode PH is inversion-symmetric on the basis of the virtual diagonal line CL2.

In addition, the pixel electrode positioned at the upper pixel electrode PH is also inversion-symmetric (e.g., minor-image symmetry) on the basis of each of a virtual horizontal center line CL3 and a virtual vertical center line CL4.

The pixel electrode positioned at the lower pixel electrode PL is also inversion-symmetric on the basis of each of the virtual diagonal line CL2, the virtual horizontal center line CL3, and the virtual vertical center line CL4.

Further, when a quadrangular region formed by connecting extended lines of two side facing the extensions 92e and 94f, an extended line of a side parallel to the gate line or the upper horizontal stem 94b at the first branch 92c positioned on the top of the horizontal stem 92b and an extended line of a side parallel to the gate line or the upper horizontal stem 94c at the first branch 92c positioned on the top of the horizontal stem 92b is referred to as a branch region A, the sum of the lengths of the branches 92c of the first pixel electrode 191a and the sum of the lengths of the branches 94d of the second pixel electrode 191b positioned in the branch region A are equal to each other and a difference between two sums is not larger than 10% and may be within a process error range. That is, the sum of the lengths of the first branches 92c is no more than about 10% difference of the sum of the lengths of the second branches 94d.

In addition, the sum of the lengths of the extensions 92e of the first pixel electrode 191a and the sum of the lengths of the extensions 94f of the second pixel electrode 191b are equal to each other and a difference between two sums is not larger than about 10% and may be within the process error range. That is, the sum of the lengths of the extensions 92e of the first pixel electrode is not larger than about 10% of the sum of the lengths of the second branches.

In some examples, if the pixel electrodes 191a and 191b are symmetric each other on the basis of the virtual horizontal center line CL1, the pixel electrode of the upper pixel electrode PH is symmetric to each of the virtual diagonal line CL2, the virtual horizontal center line CL3, and the virtual vertical center line CL4, the pixel electrode of the lower pixel electrode PL is symmetric to each of the virtual diagonal line CL2, the virtual horizontal center line CL3, and the virtual vertical center line CL4, the sum of the lengths of the branches 92c of the first pixel electrode 191a positioned in the branch region A is equal to the sum of the lengths of the branches 94d of the second pixel electrode 191b, and the sum of the lengths of the extensions 92e of the first pixel electrode 191a and the sum of the lengths of the extensions 94f of the second pixel electrode 191b are equal to each other, a luminance difference is not generated due to the symmetry between the first pixel electrode 191a and the second pixel electrode 191b, as a result, a flickering phenomenon can be reduced.

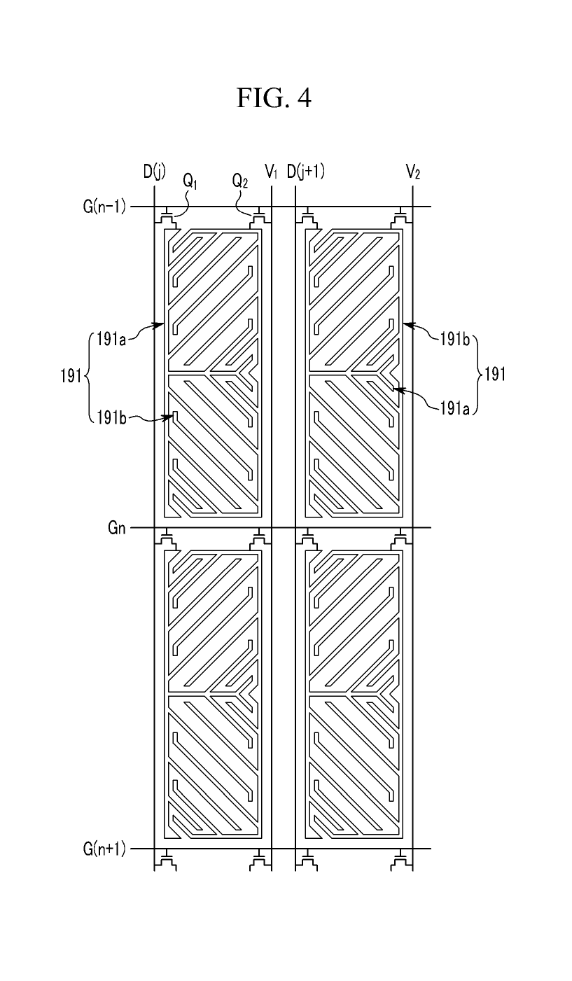

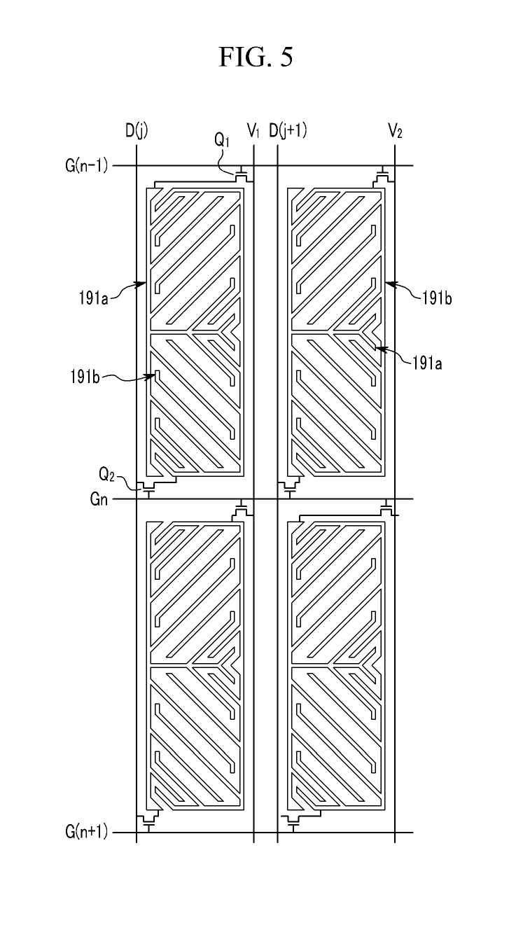

A signal can be applied to the first pixel electrode and the second pixel electrode of FIG. 3 by various methods. The methods are described in detail with reference to FIG. 4 and FIG. 5.

FIG. 4 and FIG. 5 are layout diagrams showing a connection relationship between a pixel electrode and a signal line of a liquid crystal display according to exemplary embodiments of the present invention.

Referring to FIG. 4, the liquid crystal display according to exemplary embodiments includes signal lines including a gate line Gi, data lines Dj and D(j+1) that are adjacent to each other, and voltage lines V1 and V2 that are positioned alternately with the data lines Dj and D(j+1), including first switching element Q1 and second switching element Q2 connected to the signal lines, and a first pixel electrode 191a and a second pixel electrode 191b connected to the first switching element Q1 and the second switching element Q2, respectively.

Gate lines G(i−1), Gi, and G(i+1) transfer a gate signal and the data lines Dj and D(j+1) transfer a data voltage. For example, a voltage may be equally applied or two swing voltages may alternately be applied to the first voltage line V1 and the second voltage line V2. Alternatively, different swing voltages may alternately be applied to the first voltage line V1 and the second voltage line V2 for each frame. For example, a minimum voltage and a maximum voltage which may be used by the liquid crystal display may alternately be applied to the voltage lines V1 and V2 and a swing cycle of the voltage may be one frame. The first voltage line V1 and the second voltage line V2 may be applied with a predetermined voltage or two swing voltages from a data driver like the data lines Dj and D(j+1).

The first switching element Q1 is connected to the data lines Dj and D(j+1) and the gate lines G(i−1), Gi, and G(i+1). The second switching element Q2 is connected to the voltage lines V1 and V2 and the gate lines G(i−1), Gi, and G(i+1). The first switching element Q1 and the second switching element Q2 are three-terminal elements such as a thin film transistor that are provided on the lower display panel.

The first switching element Q1 is connected to the first pixel electrode 191a and the second switching element Q2 is connected to the second pixel electrode 191b.

Next, FIG. 5 has substantially the same structure as FIG. 4, therefore, the same description may be omitted to avoid unnecessarily obscuring the present invention.

In the first pixel electrode 191a of FIG. 5, the first switching element Q1 and the second switching element Q2 are alternately connected in a column direction. In this example, the first switching element Q1 is the switching element connected to the data line and the gate line and the second switching element Q2 is the switching element connected to the voltage lines V1 and V2 and the gate lines G(i−1), Gi, and G(i+1) with reference to the liquid crystal display of FIG. 4.

The pixel electrode forms a matrix. The first pixel electrode 191a positioned on row 1 is alternately connected to the first switching element Q1 and the second switching element Q2 whenever the column of the matrix is changed and the second pixel electrode 191b positioned on row 1 is alternately connected to the second switching element Q2 and the first switching element Q1 contrary to the first pixel electrode 191a whenever the column of the matrix is changed. In addition, the first pixel electrode 191a positioned on row 2 is alternately connected to the second switching element Q2 and the first switching element Q1 contrary to the first pixel electrode 191a of row 1 whenever the column of the matrix is changed and the second pixel electrode 191b positioned on row 2 is alternately connected to the first switching element Q1 and the second switching element Q2 contrary to the second pixel electrode 191b of row 2 whenever the column of the matrix is changed. In addition, pixels having the connection relationship of row 1 and row 2 are alternately positioned when the row is changed.

Therefore, when 2*2 pixels are set as an exemplary pixel group, pixels positioned in a diagonal direction have the same connection relationship. That is, the first pixel electrode 191a of a pixel that is positioned on row 1 and column 1 is connected to the second switching element Q2, the first pixel electrode 191a of a pixel that is positioned on row 2 and column 2 is connected to the second switching element Q2, the second pixel electrode 191b of a pixel that is positioned on row 1 and column 2 is connected to the first switching element Q1, and the second pixel electrode 191b of a pixel that is positioned on row 2 and column 1 is connected to the first switching element Q1.

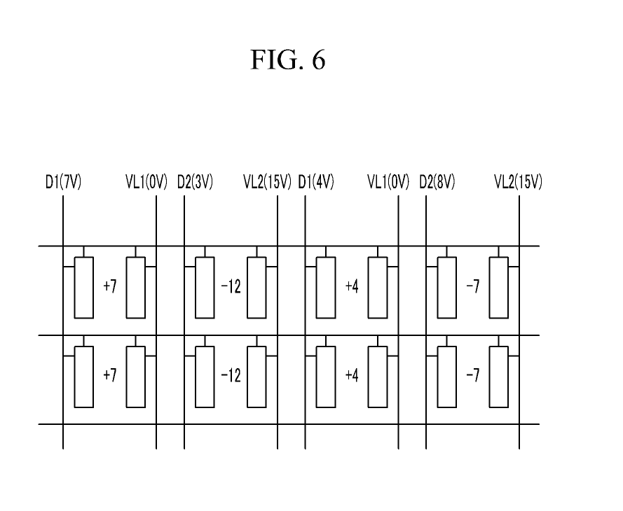

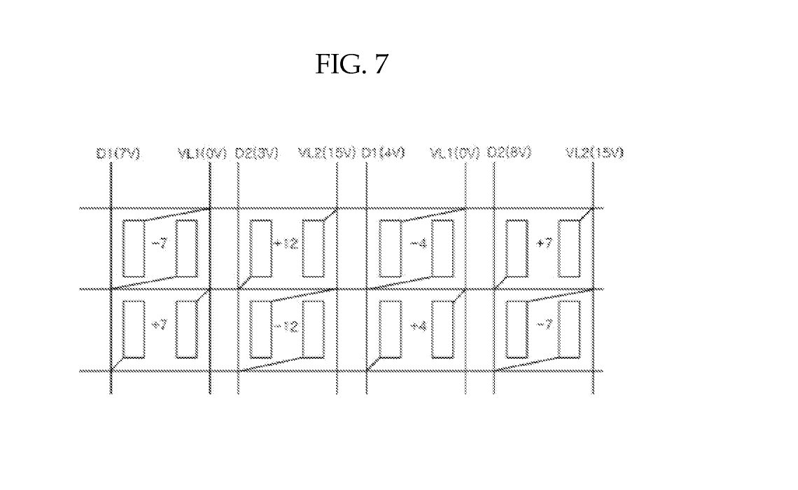

Hereinafter, referring to FIG. 6 and FIG. 7, the operations of the liquid crystal displays of FIGS. 4 and 5 are described.

FIG. 6 and FIG. 7 are diagrams showing charged voltages of liquid crystal capacitors of eight adjacent pixels and data voltages applied to data lines that are displayed in two successive frames using a minimum voltage and a maximum voltage which are 0V and 15V, respectively, in the liquid crystal display according to exemplary embodiments of the present invention.

In this example, the minimum voltage of 0V and the maximum voltage of 15V are applied to the first voltage line and the second voltage line, respectively. In addition, the voltages applied to the data lines are the maximum driving voltage, the minimum driving voltage, and a voltage therebetween.

Referring to FIG. 6, when a target charged voltage of the pixel on row 1 and column 1 is 7V, 7V is applied to the data line and when a target charged voltage of the pixel on row 1 and column 2 is 12V, 3V is applied to the data line, respectively. In addition, when a target charged voltage of the pixel on row 1 and column 3 is 4V, 4V is applied to the data line and when the target charged voltage of the pixel on row 1 and column 4 is 7V, 8V is applied to the data line. In this example, a positive data voltage is applied to odd-column pixels on the basis of the voltage of the voltage line VL1 and a negative data voltage is applied to even-column pixels on the basis of the voltage of the voltage line VL2 to enable column-inversion driving, thereby improving display characteristics.

In addition, the same data voltage is applied to even the liquid crystal display of FIG. 7 with the same target charged voltage as FIG. 6.

However, in the liquid crystal display of FIG. 7, 0V is applied to a first pixel electrode on row 1 and column 1, and 7V is applied to a second pixel electrode on row 1 and column 1 on the basis of the first pixel electrode 191a such that a negative pixel voltage is formed in the pixel on row 1 and column 1 on the basis of the first pixel electrode 191b. In addition, 7V is applied to a first pixel electrode on row 2 and column 1, and 0V is applied to the second pixel electrode 191b on row 2 and column 1 contrary to the first pixel electrode 191a such that a positive pixel voltage is formed in the pixel on row 2 and column 1 on the basis of the first pixel electrode 191a. Like this, in the layout of the pixels of FIG. 7, point-inversion driving can be acquired unlike the liquid crystal display of FIG. 6 such that it is possible to acquire a liquid crystal display which can further reduce the influence of flickering than the liquid crystal display of FIG. 6.

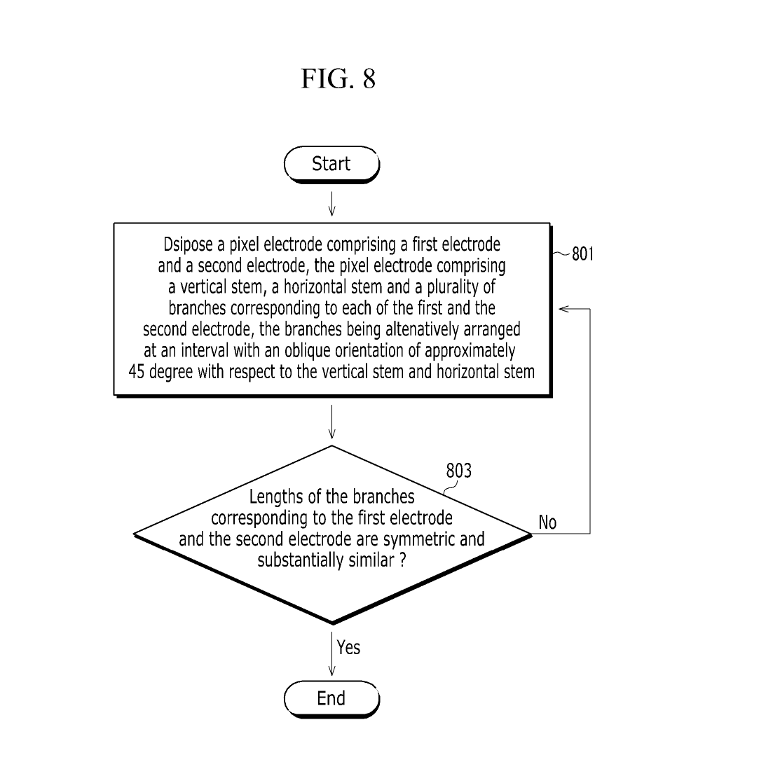

FIG. 8 is a flowchart of a process for disposing a pixel electrode capable of preventing a flickering error caused by a luminance difference according to exemplary embodiments of the present invention.

As in step 801, a pixel electrode is disposed which comprises a first electrode and a second electrode. And the pixel electrode includes a vertical stem, a horizontal stem including an upper stem, a central stem and a lower stem and a plurality of branches. Each of the branches corresponding to each of the first electrode and the second electrode is alternatively arranged at an interval with an oblique orientation approximately 45 degree with respect to the vertical stem or the horizontal stem. In some examples, the vertical stem includes a first vertical stem and a second vertical stem, and triangular shaped protrusions are disposed both ends of the first vertical stem. And a plurality of extensions are disposed on each of the branches parallel to the first vertical stem. An isosceles triangular protrusion is disposed on the middle of the second vertical stem protruding toward the horizontal stem. The first electrode further includes the triangular shaped protrusions, the first vertical stem, the central horizontal stem, the pulrality of branches and the plurality of extensions. The second electrode further comprises isosceles triangular protrusion, the upper horizontal stem, the lower horizontal stem, the plurality of branches, and the plurality of extensions. According to exemplary embodiments the pixel electrode includes a quadrangular shape. According to exemplary embodiments, the various shaped patterns may be formed by way of configurations. As in step 803, lengths of the branches corresponding to the first electrode and the second electrode are determined whether the sum of the each length is substantially similar and symmetric to each other. In some examples, a sum of lengths of the branches corresponding to first electrode is about 90% to 100% of a sum of lengths of the branches corresponding to the second electrode. In this method,

a luminance difference is not generated due to the asymmetry between the first pixel electrode 191a and the second pixel electrode 191b, as a result, a flickering phenomenon can be reduced.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A liquid crystal display, comprising:
a substrate comprising a gate line, a data line and a voltage line which crosses the gate line;
a first switching element connected to the gate line and the data line;
a second switching element connected to the gate line and the voltage line;
a first pixel electrode connected to the first switching element, the first pixel electrode comprising a plurality of first branches inclined with respect to the gate line; and
a second pixel electrode connected to the second switching element, the second electrode comprising a plurality of second branches parallel to the first branches,
wherein a sum of lengths of the first branches is substantially similar to and not more than about 10% of the sum of the lengths of the second branches.

2. The liquid crystal display of claim 1, further comprising:
a first extension connected to an end of the respective first branches to form an obtuse angle with respect to the first branches; and
a second extension connected to an end of the respective second branches to form an obtuse angle with respect to the second branches.

3. The liquid crystal display of claim 2, wherein
the first pixel electrode comprises a first vertical stem extending in parallel to the data line and a horizontal stem extending in parallel to the gate line from the center of the first vertical stem, and
the first branches obliquely extend toward upward and downward in an approximately 45 degree from the horizontal stem or the first vertical stem portion.

4. The liquid crystal display of claim 3, wherein
the second pixel electrode comprises a second vertical stem parallel to the data line, and an upper horizontal stem and a lower horizontal stem each extending toward the end of the first vertical stem from the second vertical stem.

5. The liquid crystal display of claim 4, wherein
the first pixel electrode and the second pixel electrode are symmetric to each other with respect to a horizontal center line.

6. The liquid crystal display of claim 5, wherein
an upper pixel electrodes are inversion-symmetric with respect to the horizontal center line of the upper pixel electrode, and
a lower pixel electrodes are inversion-symmetric with respect to the horizontal center line of the lower pixel electrode, and wherein the first pixel electrode and the second pixel electrode positioned in the upper part of the horizontal center lines of the first pixel electrode and the second pixel electrode are the upper pixel electrodes and the first pixel electrode and the second pixel electrode positioned in the lower part are the lower pixel electrodes.

7. The liquid crystal display of claim 6, wherein
the upper pixel electrodes are inversion-symmetric with respect to a diagonal line parallel to the first branches or the second branches, and
the lower pixel electrodes are inversion-symmetric with respect to the diagonal line parallel to the first branches or the second branches.

8. The liquid crystal display of claim 7, wherein
the upper pixel electrodes are inversion-symmetric with repect to a vertical center line of the upper pixel electrode, and
the lower pixel electrodes are inversion-symmetric with respect to a vertical center line of the lower pixel electrode.

9. The liquid crystal display of claim 5, wherein
an upper pixel electrodes are inversion-symmetric with respect to the diagonal line parallel to the first branch or the second branch, and
a lower pixel electrodes are inversion-symmetric with respect to the virtual diagonal line parallel to the first branch or the second branch, and wherein the first pixel electrode and the second pixel electrode positioned in the upper part of the horizontal center lines of the first pixel electrode and the second pixel electrode are the upper pixel electrodes and the first pixel electrode and the second pixel electrode positioned in the lower part are the lower pixel electrodes.

10. The liquid crystal display of claim 9, wherein
the upper pixel electrodes are inversion-symmetric with respect to the virtual vertical center line of the upper pixel electrode, and
the lower pixel electrodes are inversion-symmetric with respect to the virtual vertical center line of the lower pixel electrode.

11. The liquid crystal display of claim 5, wherein
an upper pixel electrodes are inversion-symmetric with respect to the virtual vertical center line of the upper pixel electrode, and
a lower pixel electrodes are inversion-symmetric with respect to the virtual vertical center line of the lower pixel electrode, and wherein the first pixel electrode and the second pixel electrode positioned in the upper part of the virtual horizontal center lines of the first pixel electrode and the second pixel electrode are the upper pixel electrodes and the first pixel electrode and the second pixel electrode positioned in the lower part are the lower pixel electrodes.

12. The liquid crystal display of claim 3, wherein
a sum of lengths of the first branches is a sum of lengths of the first branches positioned in the branch region, and
a sum of lengths of the second branches is a sum of lengths of the second branches positioned in the branch region, and wherein a region formed by connecting extended lines of two sides of the first extension and the second extension facing each other, an extended line of a side parallel to the gate line at the first branches positioned on the top of the horizontal stem, and an extended line of a side parallel to the gate line at the first branches positioned on the bottom of the horizontal stem is a branch region.

13. The liquid crystal display of claim 3, wherein
both ends of the first vertical stem form a right-angled triangle and an oblique side of the right-angled triangle is parallel to the second branches.

14. The liquid crystal display of claim 2, wherein
a sum of lengths of the first extensions is about 90% to 100% of a sum of lengths of the second extensions.

15. The liquid crystal display of claim 2, wherein
the first extension and the second extension are positioned between the first vertical stem and the second vertical stem,
the first extension is positioned more adjacent to the second vertical stem than the first vertical stem, and
the second extension is positioned more adjacent to the first vertical stem than the second vertical stem.

16. The liquid crystal display of claim 1, further comprising:
another substrate facing the substrate; and
a liquid crystal layer disposed between the substrate and the second substrate,
wherein liquid crystals of the liquid crystal layer comprises positive dielectric anisotropy.

17. The liquid crystal display of claim 16, wherein
the liquid crystals of the liquid crystal layer are vertically aligned to the substrate.

18. A liquid crystal display comprising a first substrate comprising a first pixel electrode and a second pixel electrode, a second substrate facing the first substrate, and a liquid crystal layer interposed between the first substrate and the second substrate, the display comprising:
a gate line comprising a first gate line and a second gateline disposed on the first substrate;
a data line and a voltage line crossing the gate line;
a first switching element connected to the first gate line and the voltage line; and
a second switching element connected to the second gate line and the data line,
wherein the first pixel electrode comprises a plurality of first branches inclined with respect to the gate lines, the second pixel electrode comprises a plurality of second branches inclined with respect to the gate lines, and a sum of lengths of the first branches is about 90% to 100% of a sum of lengths of the second branches, and wherein
the first pixel electrode positioned on a first row of a matrix is alternately connected to the first switching element and the second switching element corresponding to changing of the column of the matrix, and
the second pixel electrode positioned on a first row of the matrix is alternately connected to the second switching element and the first switching element inverse to the first pixel electrode corresponding to changing of the column of the matrix.

19. The liquid crystal display of claim 18, wherein:
the first pixel electrode positioned on a second row of the matrix is alternately connected to the second switching element and the first switching element inverse to the first pixel electrode of the first row corresponding to changing of the column of the matrix, and
the second pixel electrode positioned on a second row of the matrix is alternately connected to the first switching element and the second switching element inverse to the first pixel electrode of the second row corresponding to changing of the column of the matrix.

20. The liquid crystal display of claim 19, further comprising:
a first extension connected to an end of the respective first branches to form an obtuse angle with respect to the first branches; and
a second extension connected to an end of the respective second branches to form an obtuse angle with respect to one of the second branches.

21. The liquid crystal display of claim 20, wherein
the first pixel electrode comprises a first vertical stem extending in parallel to the data line and a horizontal stem extending in parallel to the gate line from the center of the first vertical stem, and
the first branches obliquely extend toward upward and downward in an approximately 45 degree from the horizontal stem or the first vertical stem.

22. The liquid crystal display of claim 21, wherein
the second pixel electrode comprises a second vertical stem parallel to the data line, and an upper horizontal stem and a lower horizontal stem each extending toward the end of the first vertical stem from the second vertical stem.

23. The liquid crystal display of claim 22, wherein
the first pixel electrode and the second pixel electrode are symmetric to each other with respect to a virtual horizontal center line.

24. The liquid crystal display of claim 23, wherein
an upper pixel electrodes are inversion-symmetric with respect to the virtual horizontal center line of the upper pixel electrode, and
a lower pixel electrodes are inversion-symmetric with respect to the virtual horizontal center line of the lower pixel electrode, and wherein the first pixel electrode and the second pixel electrode positioned in the upper part of the virtual horizontal center lines of the first pixel electrode and the second pixel electrode are the upper pixel electrodes and the first pixel electrode and the second pixel electrode positioned in the lower part are lower pixel electrodes.

25. The liquid crystal display of claim 24, wherein
the upper pixel electrodes are inversion-symmetric with respect to a virtual diagonal line parallel to the first branches or the second branches, and
the lower pixel electrodes are inversion-symmetric with respect to the diagonal line parallel to the first branches or the second branches.

26. The liquid crystal display of claim 25, wherein
the upper pixel electrodes are inversion-symmetric with respect to a virtual vertical center line of the upper pixel electrode, and
the lower pixel electrodes are inversion-symmetric with respect to a virtual vertical center line of the lower pixel electrode.

27. The liquid crystal display of claim 23, wherein
an upper pixel electrodes are inversion-symmetric with respect to the virtual diagonal line parallel to the first branches or the second branches, and
a lower pixel electrodes are inversion-symmetric with respect to the virtual diagonal line parallel to the first branches or the second branches, and wherein the first pixel electrode and the second pixel electrode positioned in the upper part of the virtual horizontal center lines of the first pixel electrode and the second pixel electrode are the upper pixel electrodes and the first pixel electrode and the second pixel electrode positioned in the lower part are the lower pixel electrodes.

28. The liquid crystal display of claim 27, wherein
the upper pixel electrodes are inversion-symmetric with respect to the vertical center line of the upper pixel electrode, and
the lower pixel electrodes are inversion-symmetric with respect to the virtual vertical center line of the lower pixel electrode.

29. The liquid crystal display of claim 23, wherein
an upper pixel electrodes are inversion-symmetric with respect to the virtual vertical center line of the upper pixel electrode, and
a lower pixel electrodes are inversion-symmetric with respect to the virtual vertical center line of the lower pixel electrode, and wherein the first pixel electrode and the second pixel electrode positioned in the upper part of the virtual horizontal center lines of the first pixel electrode and the second pixel electrode are the upper pixel electrodes and the first pixel electrode and the second pixel electrode positioned in the lower part are the lower pixel electrodes.

30. The liquid crystal display of claim 21, wherein
a sum of lengths of the first branches is a sum of lengths of the first branches positioned in the branch region, and
a sum of lengths of the second branches is a sum of lengths of the second branches positioned in the branch region, and wherein a region formed by connecting extended lines of two sides of the first extension and the second extension facing each other, an extended line of a side parallel to the gate line at the first branches positioned on the top of the horizontal stem, and an extended line of a side parallel to the gate line at the first branches positioned on the bottom of the horizontal stem is a branch region.

31. The liquid crystal display of claim 21, wherein
both ends of the first vertical stem form a right-angled triangle and an oblique side of the right-angled triangle is parallel to the second branches.

32. The liquid crystal display of claim 20, wherein
a sum of lengths of the first extension is about 90% to 100% of a sum of lengths of the second extension.

33. The liquid crystal display of claim 20, wherein
the first extension and the second extension are positioned between the first vertical stem and the second vertical stem,
the first extension is positioned more adjacent to the second vertical stem than the first vertical stem, and
the second extension is positioned more adjacent to the first vertical stem than the second vertical stem.

34. The liquid crystal display of claim 20, wherein
liquid crystals of the liquid crystal layer comprise positive dielectric anisotropy.

35. The liquid crystal display of claim 34, wherein
the liquid crystals of the liquid crystal layer are vertically aligned to the first substrate.

36. A method comprising:
disposing a pixel electrode comprising a first electrode and a second electrode and the pixel electrode comprising a vertical stem, a horizontal stem comprising an upper stem, a central stem and a lower stem and a plurality of branches, wherein the respective branches corresponding to each of the first electrode and the second electrode is alternatively arranged at an interval with an oblique orientation approximately 45 degree with respect to the vertical stem or the horizontal stem.

37. The method of claim 36, wherein the vertical stem comprises a first vertical stem and a second vertical stem, and wherein triangular shaped protrusions are disposed both ends of the first vertical stem and a plurality of extensions are disposed on each of the branches parallel to the first vertical stem.

38. The method of claim 37, wherein an isosceles triangular protrusion is disposed on the middle of the second vertical stem protruding toward the horizontal stem.

39. The method of claim 37, wherein the first electrode further comprises the triangular shaped protrusions, the first vertical stem, the central horizontal stem, the pulrality of branches and the plurality of extensions.

40. The method of claim 38, wherein the second electrode further comprises isosceles triangular protrusion, the upper horizontal stem, the lower horizontal stem, the plurality of branches, and the plurality of extensions.

41. The method of claim 36, wherein the pixel electrode comprises a quadrangular shape.

42. The method of claim 36, wherein the sum of the lengths of the branches corresponding to the first electrode is substantially same to the sum of the lengths of the branches corresponding to the second electrode.

43. The method of claim 36, wherein the sum of the lengths of the extensions corresponding to the first electrode is substantially the same to the sum of the lengths of the extensions corresponding to the second electrode.
